(19) United States
(12) Patent Application Publication
(10) Pub. No.: US 2008/0140660 A1
(43) Pub. Date: Jun. 12, 2008

(54) System and Method for File Authentication and Versioning Using Unique Content Identifiers

(75) Inventors: Ryuji Masuda, Los Angeles, CA (US); Mustafa Noorzai, Santa Rosa Valley, CA (US)

Correspondence Address: WHITE & CASE LLP;PATENT DEPARTMENT, 1155 AVENUE OF THE AMERICAS, NEW YORK, NY, 10036, US

(73) Assignee: CASDEX, INC., Santa Rosa Valley, CA (US)

(21) Appl. No.: 11/945,503

(22) Filed: Nov. 27, 2007

Related U.S. Application Data
(60) Provisional application No. 60/873,337, filed on Dec. 8, 2006.

(51) Int. Cl. G06F 17/30; G06F 12/00

(52) U.S. Cl. 707/6; 711/108; 707/E17.017; 711/E12.001

(57) ABSTRACT

One embodiment of a method for file authentication and versioning includes receiving a request to retrieve a data element identified by a content identifier, identifying a storage location associated with the content identifier, retrieving a data element stored at the storage location, calculating a second content identifier of the retrieved data element, comparing the content identifier and the second content identifier, if the content identifier and the second content identifier match, providing a preview of the retrieved data element and a representation of the content identifier to be displayed to a user. The representation of the content identifier may be an alphanumeric string derived from the content identifier or a graphic representation, such as a barcode, derived from the content identifier.

### CROSS-REFERENCE TO RELATED APPLICATION

This application claims the benefit of U.S. Provisional Patent Application No. 60/873,337, entitled “File Authentication and Versioning Using Unique Identifiers,” filed on Dec. 8, 2006. The subject matter of the related application is hereby incorporated by reference.

### FIELD OF THE INVENTION

This invention relates generally to content addressable storage and relates more particularly to a system and method for file authentication and versioning using unique content identifiers.

### BACKGROUND

Content addressable storage (CAS) is a technique for storing a segment of electronic information that can be retrieved based on its content, not on its storage location. When information is stored in a CAS system, a content identifier is created and linked to the information. The content identifier is then used to retrieve the information. The content identifier is stored with an identifier of where the information is stored. When information is to be stored, a cryptographic algorithm is used to create the content identifier that is ideally unique to the information. The content identifier is then compared to a list of content identifiers for information already stored on the system. If the content identifier is found on the list, the information is not stored a second time. Thus a typical CAS system does not store duplicates of information, providing efficient storage. If the content identifier is not already on the list, the information is stored, and the content identifier is stored in the table with the location of the information.

Content addressable storage is most commonly used to store information that does not change, such as archived emails, financial records, medical records, and publications. Content addressable storage is highly suited to storing information required by compliance programs because the content can be verified as not having changed. Content addressable storage is also highly suited for storing documents that may need to be produced in litigation discovery. A document that can be produced with a content identifier that was created using a reliable cryptographic algorithm can establish the authenticity of the document. When information is retrieved from a CAS system, a content identifier is provided, and the location corresponding to that content identifier is looked up and the information is retrieved. The content identifier is then recalculated based on the content of the retrieved information and the newly-calculated content identifier is compared to the provided content identifier to verify that the content has not changed.

But all of the verification and authentication done by a typical CAS system occurs in the background. Most CAS systems are behind many network layers and the operation of the CAS system is transparent to the user. A user must take it on faith that the document or other information being retrieved is indeed the information that was originally stored. This is a problem in a compliance or litigation discovery situation where it can be critical to be able to show that the retrieved information has not been modified.

### SUMMARY

One embodiment of a method for file authentication and versioning includes receiving a request to retrieve a data element, determining a stored content identifier for the data element, identifying a storage location associated with the stored content identifier, retrieving a data element stored at the storage location, calculating a second content identifier of the retrieved data element, comparing the stored content identifier and the second content identifier, and if the stored content identifier and the second content identifier match, providing a preview of the retrieved data element and a representation of the stored content identifier to be displayed to a user. The representation of the stored content identifier may be an alphanumeric string derived from the content identifier or a graphic representation, such as a barcode, derived from the content identifier. Displaying both the preview and content identifier representation allows a user to confirm that the content of the data element is authentic, i.e., that the retrieved data element is exactly the same as the data element that was stored in the content storage.

One embodiment of a system for file authentication and versioning includes a content addressable storage manager configured to control the storing and retrieving of data elements to a content storage, a content addressable storage interface configured to simultaneously display a preview of a data element retrieved from the content storage and a content identifier representation associated with the data element to a user, and a content addressable storage application configured to communicate with the content addressable storage manager and the content addressable storage interface. The content addressable storage manager is further configured to calculate a second content identifier for a retrieved data element and the content addressable storage application is further configured to compare the second content identifier with a stored content identifier for the data element to confirm that the content of the data element is authentic. The content addressable storage interface is further configured to provide a graphical user interface that allows a user to select any one of a plurality of previews in an archive of data elements for display.

### BRIEF DESCRIPTION OF THE DRAWINGS

FIG. 1 is a block diagram of one embodiment of a system including a content addressable storage system, in accordance with the present invention;

FIG. 2 is a flowchart of method steps for storing a data element into the content addressable storage system of FIG. 1, according to one embodiment of the invention;

FIG. 3 is a flowchart of method steps for retrieving a data element from the content addressable storage system of FIG. 1, according to one embodiment of the invention;

FIG. 4 is a flowchart of method steps for retrieving a data element from the content addressable storage system of FIG. 1, according to another embodiment of the invention;

FIG. 5 is a diagram of one embodiment of a graphical user interface, in accordance with the invention; and

FIG. 6 is a diagram of another embodiment of a graphical user interface, in accordance with the invention.

### DETAILED DESCRIPTION

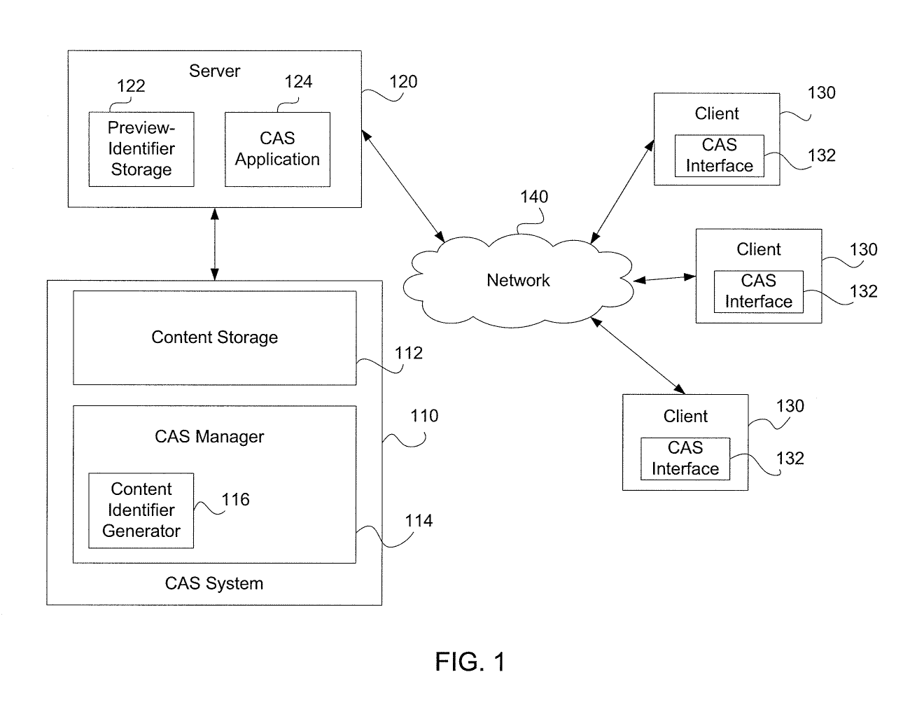

FIG. 1 is a block diagram of one embodiment of a system including, but not limited to, a content addressable storage (CAS) system 110, a server 120, a network 140, and a plurality of clients 130. CAS system 110 includes content storage 112 and a CAS manager 114. Content storage 112 may store data elements of any type, including documents, images, video files, audio files, and emails. Large files may be divided into more than one data element that are stored separately. Content storage 112 is preferably embodied as an array of magnetic disks, but can also be embodied as optical disks, tape, or a combination of magnetic disks, optical disks, and tapes. CAS manager 114 controls the writing of data elements to content storage 112 and controls the reading of data elements from content storage 112. Before writing a data element to content storage 112, CAS manager 114 creates a content identifier for that data element using content identifier generator 116. Content identifier generator 116 applies a cryptographic algorithm to the content of the data element to generate a unique content identifier for the data element. Content identifier generator 116 also applies the cryptographic algorithm to metadata associated with the data element to generate a metadata identifier. In one embodiment, the cryptographic algorithm is the well-known MD5 cryptographic hash algorithm that produces a 128-bit number derived from the content of a data element; however any other cryptographic algorithm may be used to generate content identifiers so long as the probability of generating identical content identifiers for different data elements using that algorithm is below an acceptable threshold.

Clients 130 communicate with server 120 via network 140 to store and retrieve content from CAS system 110. Client 130 may be any general computing device such as a personal computer, a workstation, a laptop computer, or a handheld computer. Client 130 includes a CAS interface 132 that is configured to enable a user of client 130 to store content in CAS system 110 and to retrieve content from CAS system 110. CAS interface 132 includes a graphical user interface (GUI) that provides information to a user and enables the user to provide inputs to CAS interface 132. Network 140 may be any type of communication network such as a local area network or a wide area network, and may be wired, wireless, or a combination.

Server 120 includes a CAS application 124 that is configured to communicate with clients 130 and CAS system 110. In one embodiment, CAS application 124 is configured to communicate with clients 130 using a standard communication protocol such as a TCP/IP protocol, and is configured to communicate with CAS system 110 using a storage network protocol such as Fibre Channel. Server 120 also includes a preview-identifier storage 122 that stores previews of data elements stored in CAS system 110, content identifiers and metadata identifiers associated with the previews, and storage location identifiers associated with the previews. In one embodiment, a preview is a “thumbnail” image of a data element; however other types of previews are within the scope of the invention.

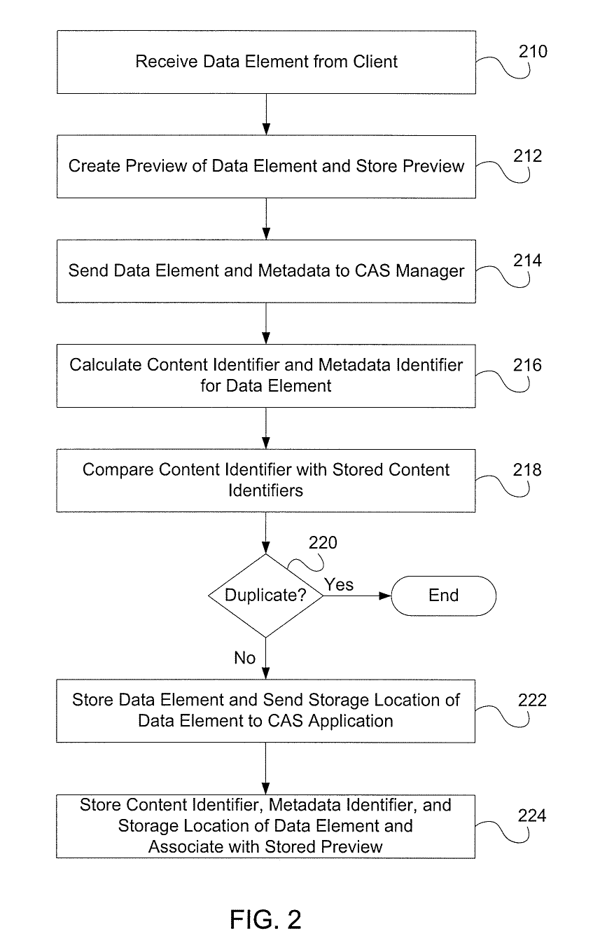

FIG. 2 is a flowchart of method steps for storing a data element into the content addressable storage system of FIG. 1, according to one embodiment of the invention. In step 210, CAS application 124 receives a data element from client 130. A user of client 130 selects a data element and indicates via CAS interface 132 that the data element is to be stored in CAS system 112. In step 212, CAS application 124 creates a preview of the data element and stores the preview in preview-identifier storage 122. In step 214, CAS application 124 sends the data element and metadata associated with the data element to CAS manager 114. The metadata may include a filename, filepath, filesize, author, and/or date. In step 216, content identifier generator 116 calculates a content identifier for the data element using a cryptographic algorithm and calculates a metadata identifier for the metadata associated with the data element. In step 218, CAS manager 114 sends the content identifier of the data element and the metadata identifier to CAS application 124, which compares the content identifier with the content identifiers stored in preview-identifier storage 122 to determine if a duplicate of the data element has been previously stored in CAS system 110. In step 220, if the content identifier is not a duplicate, the method continues with step 222, in which CAS manager 114 writes the data element to content storage 112 and sends the storage location identifier to CAS application 124. Then in step 224, CAS application 124 stores the content identifier, metadata identifier, and storage location identifier of the data element in preview-identifier storage 112 and associates the content identifier, metadata identifier and storage location identifier with the preview of the data element in preview-identifier storage 112. In one embodiment, preview-identifier storage 112 includes a table that reflects the relationships between a preview of a data element, the content identifier and metadata identifier of that data element, and the storage location of that data element in content storage 112. Returning to step 220, if the content identifier is a duplicate, the method ends because the data element has been previously stored in content storage 112.

The data element to be stored may be a revised version of a data element that has been stored in CAS system 110. For each data element to be stored, CAS application 124 queries preview-identifier storage 122 to determine if a data element with the same filename as the current data element has been previously stored in CAS system 110. If there is only one other data element with that filename stored, CAS application 124 creates an archive that includes the previews, content identifiers, and metadata identifiers of both data elements and will store the previews, content identifiers, and metadata identifiers of all future versions (each a separate data element) for that filename in the archive. If an archive having that filename already exists, CAS application 124 will add the preview, content identifier, and metadata identifier of the data element to the archive.

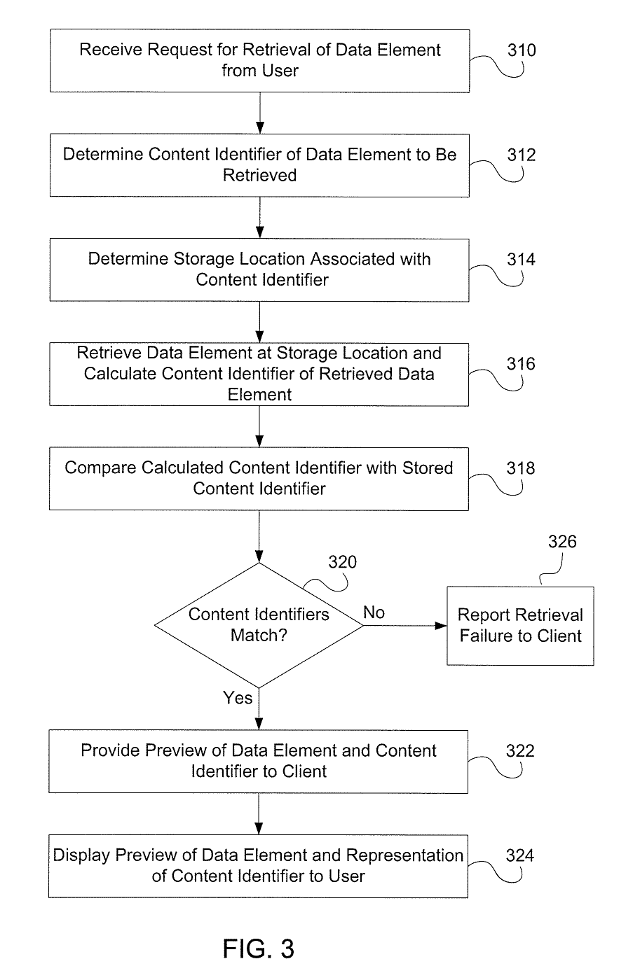

FIG. 3 is a flowchart of method steps for retrieving a data element from the content addressable storage system of FIG. 1, according to one embodiment of the invention. In step 310, CAS application 124 receives a request for retrieval of a preview of a data element from a user via CAS interface 132. In one embodiment, CAS application 124 provides a listing of data elements stored in content storage 112 to CAS interface 132, where the listing identifies the data elements by filename or other metadata. A user then provides input to CAS interface 132 to identify the data element to be retrieved, such as by clicking on a filename displayed by a GUI, and CAS interface 132 sends the selected filename to CAS application 124. In step 312, CAS application 124 determines the content identifier of the data element to be retrieved. In one embodiment, CAS application queries preview-identifier storage 122 for the content identifier that is associated with the filename or other metadata provided by CAS interface 132. In step 314, CAS application 124 determines the storage location associated with the content identifier and provides the storage location to CAS manager 114. In step 316, CAS manager 114 retrieves the data element at the storage location provided by CAS application 124 from content storage 112, calculates the content identifier for the retrieved data element using content identifier generator 116, and sends the retrieved data element and the newly-calculated content identifier to CAS application 124. In step 318, CAS application 124 compares the newly-calculated content identifier with the content identifier stored in preview-identifier storage 122.

In step 320, if the content identifiers match, the method continues with step 322, in which CAS application 124 provides the content identifier and the preview associated with the content identifier to CAS interface 132 at the requesting client 130. In step 324, CAS interface 132 displays the preview of the data element and a representation of the content identifier to the user via the GUI. In one embodiment, the representation of the content identifier is a 26 character alphanumeric string derived from the content identifier; however any representation of the content identifier derived from the content identifier, and the content identifier itself, that is capable of being visually represented to a user is within the scope of the present invention. Examples of content identifier representations are alphanumeric strings, and graphical representations such as one-dimensional or two-dimensional barcodes. The user may then request display of the data element via the GUI, and the data element can be viewed, printed, copied to a removable media, or otherwise processed.

Returning to step 320, if the content identifiers do not match, the method continues with step 326, in which CAS application 124 reports the failure to retrieve the requested data element to CAS interface 132 of the requesting client 130.

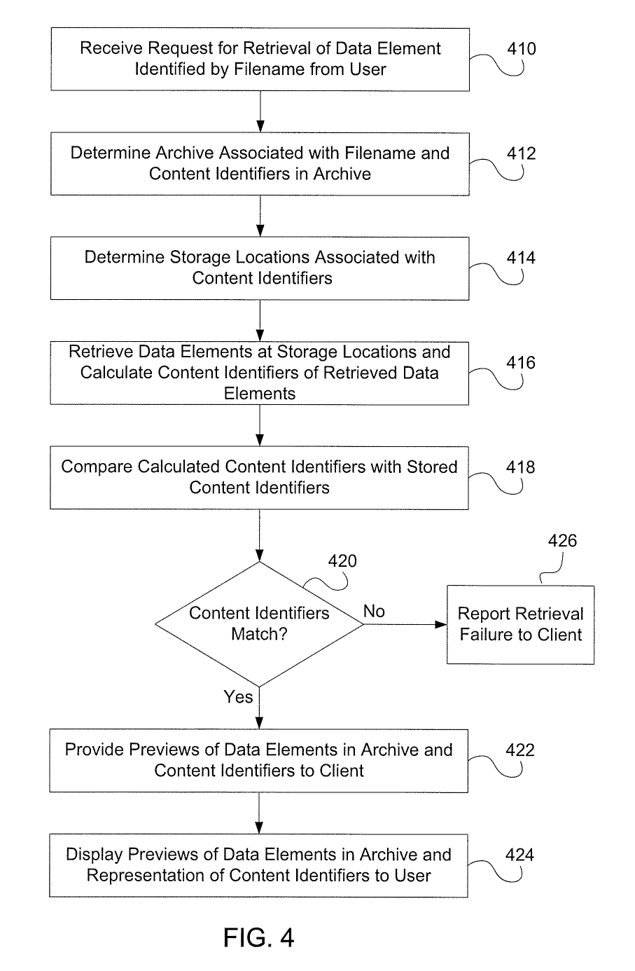

FIG. 4 is a flowchart of method steps for retrieving data elements from CAS system 110, according to one embodiment of the invention. In step 410, CAS application 124 receives a request for the retrieval of a data element by filename. In step 412, CAS application 124 identifies an archive having the filename and the content identifiers for all data elements associated with the archive. In step 414, CAS application 124 determines the storage locations for the identified content identifiers. In step 416, CAS application 124 sends the storage location identifiers to CAS manager 114, and CAS manager 114 retrieves the data elements at those storage locations from content storage 112 and calculates content identifiers for the retrieved data elements using content identifier generator 116. CAS manager 114 then sends the newly-calculated content identifiers to CAS application 124. In step 420, CAS application 124 compares the newly-calculated content identifiers to the stored content identifiers. If in step 420 the content identifiers match, the method continues with step 422, in which CAS application 124 provides the previews of the data elements in the archive and the content identifiers to the requesting client 130. In step 424, CAS interface 132 of the requesting client displays the previews of the data element in the archive and representations of the content identifiers to the user via a GUI. The user may then request display of one or more of the data elements in the archive via the GUI, and the data element can be viewed, printed, copied to a removable media, or otherwise processed.

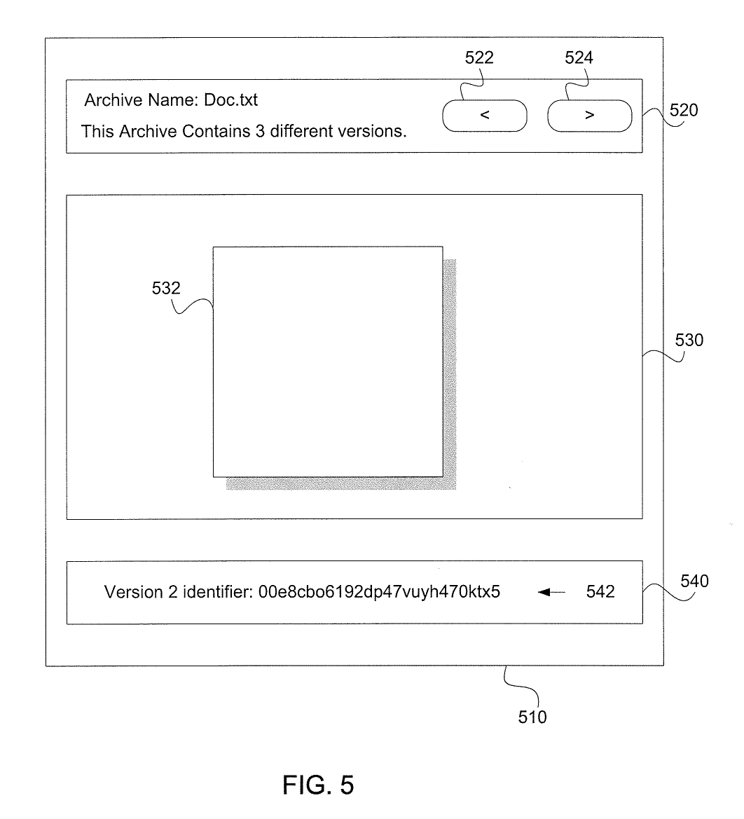

FIG. 5 is a diagram of one embodiment of a graphical user interface (GUI) 510, in accordance with the invention. GUI 510 is generated by CAS interface 132 to enable a user at client 130 to interact with CAS system 110. GUI 510 includes, but is not limited to, a navigation pane 520, a preview pane 530, and an identifier pane 540. Navigation pane 520 displays the name of an archive including the data element for which a preview 532 is being displayed in preview pane 530. Navigation pane 520 indicates how many versions are contained in the archive, i.e., how many different data elements are associated with the archive, and includes buttons 522 and 524 that allow a user to navigate between previews for the different versions of the currently displayed archive. Identifier pane 540 displays the content identifier representation 542 for the data element corresponding to preview 532 currently shown in preview pane 530 and an identification of the version that corresponds to preview 532. In the FIG. 5 embodiment, content identifier representation 542 is a 26 alphanumeric string derived from the content identifier. By displaying both preview 532 and content identifier representation 542, CAS interface 132 provides confirmation to the user that the content of the data element is authentic, i.e., that the retrieved data element is exactly the same as the data element that was stored in CAS system 110. GUI 510 may also include a toolbar (not shown) that allows a user to view, print, copy, or otherwise process a data element.

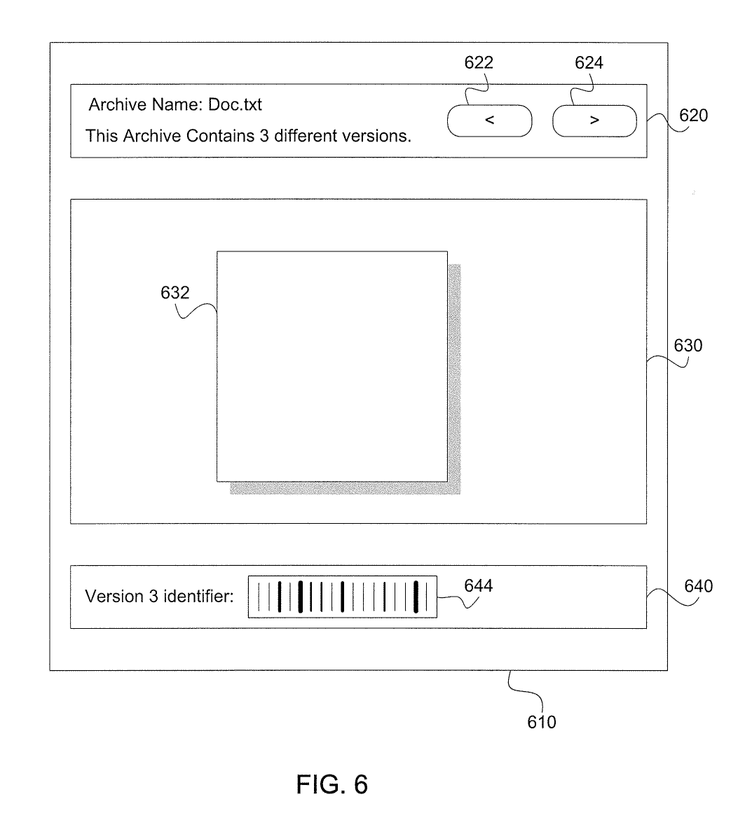

FIG. 6 is a diagram of another embodiment of a graphical user interface (GUI) 610, in accordance with the invention. GUI 610 is generated by CAS interface 132 to enable a user at client 130 to interact with CAS system 110. GUI 610 includes, but is not limited to, a navigation pane 620, a preview pane 630, and an identifier pane 640. Navigation pane 620 displays the name of an archive including the data element for which a preview 632 is being displayed in preview pane 630. Navigation pane 620 indicates how many versions are contained in the archive, i.e., how many different data elements are associated with the archive, and includes buttons 622 and 624 that allow a user to navigate between previews for the different versions of the currently displayed archive. Identifier pane 640 displays the content identifier representation 644 of the data element corresponding to preview 632 currently shown in preview pane 630 and an identification of the version that corresponds to preview 632. In the FIG. 6 embodiment, content identifier representation 644 is a barcode that was derived from the content identifier. By displaying both preview 632 and content identifier representation 644, CAS interface 132 provides confirmation to the user that the content of the data element is authentic, i.e., that the retrieved data element is exactly the same as the data element that was stored in CAS system 110. GUI 610 may also include a toolbar (not shown) that allows a user to view, print, copy, or otherwise process a data element.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method comprising:
receiving a request to retrieve a data element;
determining a stored content identifier of the data element;
identifying a storage location associated with the stored content identifier;
retrieving a data element stored at the storage location;
calculating a second content identifier of the retrieved data element;
comparing the stored content identifier and the second content identifier; and
if the stored content identifier and the second content identifier match, providing a preview of the retrieved data element and a representation of the stored content identifier to be displayed to a user.

2. The method of claim 1, wherein calculating a second content identifier comprises applying a cryptographic algorithm to the content of the retrieved data element.

3. The method of claim 2, wherein the stored content identifier was generated using the cryptographic algorithm.

4. The method of claim 1, wherein the representation of the stored content identifier is an alphanumeric string derived from the stored content identifier.

5. The method of claim 1, wherein the representation of the stored content identifier is a graphical representation derived from the content identifier.

6. The method of claim 1, wherein the preview of the retrieved data element is one of a plurality of previews associated with an archive.

7. A system comprising:
a content addressable storage manager configured to control the storing and retrieving of data elements to a content storage;
a content addressable storage interface configured to simultaneously display a preview of a data element retrieved from the content storage and a content identifier representation associated with the data element to a user; and
a content addressable storage application configured to communicate with the content addressable storage manager and the content addressable storage interface.

8. The system of claim 7, wherein the content addressable storage manager includes a content identifier generator that applies a cryptographic algorithm to the content of a data element to produce a content identifier for the data element.

9. The system of claim 7, wherein the content addressable storage manager is further configured to calculate a second content identifier for a retrieved data element and the content addressable storage application is further configured to compare the second content identifier with a stored content identifier for the data element to confirm that the content of the data element is authentic.

10. The system of claim 9, wherein the content addressable storage manager includes a content identifier generator configured to apply a cryptographic algorithm to the content of the retrieved data element to calculate the second content identifier.

11. The system of claim 7, wherein the content addressable storage manager is further configured to calculate a content identifier for a data element to be stored in the content storage.

12. The system of claim 7, wherein the content addressable storage application is further configured to manage the storage of previews of data elements and content identifiers associated with the data elements.

13. The system of claim 7, wherein the preview is one of a plurality of previews associated with an archive.

14. The system of claim 13, wherein the content addressable storage interface is further configured to provide a graphical user interface that allows a user to select any one of the plurality of previews in the archive for display.

15. A computer-readable medium storing instructions for causing a computer to perform:
receiving a request to retrieve a data element;
determining a stored content identifier of the data element;
identifying a storage location associated with the stored content identifier;
retrieving a data element stored at the storage location;
calculating a second content identifier of the retrieved data element;
comparing the stored content identifier and the second content identifier; and
if the stored content identifier and the second content identifier match, providing a preview of the retrieved data element and a representation of the stored content identifier to be displayed to a user.

16. The computer-readable medium of claim 15, wherein calculating a second content identifier comprises applying a cryptographic algorithm to the content of the retrieved data element.

17. The computer-readable medium of claim 16, wherein the stored content identifier was generated using the cryptographic algorithm.

18. The computer-readable medium of claim 15, wherein the representation of the stored content identifier is an alphanumeric string derived from the content identifier.

19. The computer-readable medium of claim 15, wherein the representation of the stored content identifier is a graphical representation derived from the content identifier.

20. The computer-readable medium of claim 15, wherein the preview of the retrieved data element is one of a plurality of previews associated with an archive.
